(19) United States
(12) Patent Application Publication
(10) Pub. No.: US 2005/0265390 A1
(43) Pub. Date: Dec. 1, 2005

(54) Apparatus and method for transmitting data in broadband wireless communication system and apparatus and method for receiving data in the same

(75) Inventors: Kang-Gyu Lee, Gyeonggi-do (KR); Yun-Sung Kim, Gyeonggi-do (KR); Jong-Hyun Won, Seoul (KR); Tae-In Hyon, Gyeonggi-do (KR); Sun-Ny Chang, Gyeonggi-do (KR)

Correspondence Address: DILWORTH & BARRESE, LLP, 333 EARLE OVINGTON BLVD., UNIONDALE, NY, 11553, US

(73) Assignee: SAMSUNG ELECTRONICS CO., LTD., Gyeonggi-do (KR)

(21) Appl. No.: 11/141,671

(22) Filed: May 31, 2005

(30) Foreign Application Priority Data
Jun. 1, 2004 (KR) 39848-2004

(51) Int. Cl. H04J 3/24

(52) U.S. Cl. 370/469

(57) ABSTRACT

Disclosed is a method for transmitting and receiving MAC PDUs in a broadband wireless communication system. A transmitter generates a MAC PDU and determines if an empty area exists in the PDU. If the empty area exists, the transmitter determines if there exists a complete SDU for transmission having a size that is less than or equal to the size of the empty area. If the complete SDU exists, the transmitter adds into the PDU as a last payload piece the SDU without a subheader, and sets a GMH of the PDU to indicate that a No Overhead Last complete SDU (NOLS) exists, and transmits the PDU. A receiver analyzes a GMH of a received MAC PDU and determines if an NOLS exists in the PDU. If the NOLS exists, the receiver sequentially monitors the PSHs in the PDU to detect the last PSH, and separates an SDU corresponding to the NOLS from the PDU with reference to the last PSH.

### PRIORITY

This application claims priority to an application entitled “APPARATUS AND METHOD FOR TRANSMITTING DATA IN BROADBAND WIRELESS COMMUNICATION SYSTEM AND APPARATUS AND METHOD FOR RECEIVING DATA IN THE SAME”, filed in the Korean Intellectual Property Office on Jun. 1, 2004 and assigned Serial No. 2004-0039848, the contents of which are hereby incorporated by reference.

### BACKGROUND OF THE INVENTION

1. Field of the Invention

The present invention relates to an apparatus and a method for transmitting data in a broadband wireless communication system and an apparatus and a method for receiving data in the same.

2. Description of the Related Art

FIG. 1 is a diagram showing the configuration of a general broadband wireless communication system. In FIG. 1, Subscriber Stations (SSs) 10 and 12 are mobile SSs and are connected to a backbone network 30 through Base Stations (BSs) 20 and 22. The SSs 10 and 12 are connectable between the BSs 20 and 22 and subscribers. The BSs 20 and 22 control and manage the SSs 10 and 12 and provide connectivity thereto.

The backbone network 30 is connected to an Authentication and Service authorization (ASA) Server 40 for authentication and service authorization of the SSs 10 and 12. Each of the SSs 10 and 12 has a Medium Access Control (MAC) layer and a physical (PHY) layer. The protocol stack of the SSs 10 and 12 will now be described with reference to FIGS. 2A and 2B.

FIG. 2A shows a protocol stack architecture of a subscriber station in a general broadband wireless communication system, and FIG. 2B illustrates packing of Service Data Units (SDUs) into a Protocol Data Unit (PDU) and fragmentation of an SDU into PDUs.

In FIG. 2a, a higher layer 130 transfers a data packet from a service provider or a private IP network to a service specific Convergence Sub-layer (CS) 124 of a MAC layer 120. A CS Service Access Point (SAP) is provided between the higher layer 130 and the CS 124, which is the highest layer of the MAC layer 120.

The CS 124 converts the data packet to a MAC SDU and transfers the MAC SDU to a MAC Common Part Sub-layer (CPS) 122. The MAC CPS 122 converts the MAC SDU to a MAC Protocol Data Unit (PDU) and transfers the MAC PDU to a PHY layer 110. The size of the MAC SDU to be converted to a MAC PDU may be of a size different from a MAC PDU size prescribed to be suitable for transmission. Due to this size difference, a packing or fragmentation process is required in the procedure for forming the MAC PDU.

If the size of each MAC SDU to be transmitted is smaller than the rescribed MAC PDU size, packing is performed so that a plurality of MAC SDUs are included in one MAC PDU. The packing is a process performed in the CPS for collecting a plurality of MAC SDUs and forming one MAC PDU. If the MAC SDUs have different sizes, a Packing Subheader (PSH) is appended to the beginning of each of the MAC SDUs packed in the same MAC PDU. In FIG. 2B, SDUs 150 and 152 are packed into one PDU 154.

If the size of a MAC SDU to be transmitted is larger than the prescribed MAC SDU size, fragmentation is performed so that the MAC SDU is separated into a plurality of MAC PDUs. The fragmentation is a process performed in the CPS for separating one MAC SDU into two or more MAC PDUs for efficient use of bandwidth according to QoS (Quality of Service) requirements. A Fragmentation Subheader (PSH) is appended to the beginning of a MAC SDU fragment included in a MAC PDU. In FIG. 2B, one SDU 160 is fragmented into two PDUs 162 and 164. The two PDUs 162 and 164 each include one of two fragments of the SDU 160 (i.e. segmented SDUs).

Such MAC PDUs are mainly divided into MAC PDUs having a Generic MAC Headers (GMH), and MAC PDUs having only a bandwidth request header. The present invention will handle a MAC PDU that carries a general MAC management message and user data in its payload. This MAC PDU uses a GMH as its header.

FIG. 3 is a diagram showing a general structure of such a MAC PDU. As shown in FIG. 3, the general MAC PDU 170 includes a GMH 172, a payload 174 including a general MAC management message and user data, and a CRC (Cyclic Redundancy Check) 176 for error checking. The MAC PDU 170 does not include the CRC 176 for a non-ARQ connection. The GMC 172 is a MAC PDU protocol header with a fixed length of 6 bytes.

FIG. 4 shows a GMH structure and details of GMH fields proposed in the IEEE specification 802.16REVd/D4. As shown in FIG. 4, a MAC in a transmitter uses a 6-bit type field to inform a MAC in a receiver of whether or not a special payload and a subheader exist in a corresponding MAC PDU. From among the subheaders which can be included in the MAC PDU, a Packing Subheader (PSH) or a Fragmentation Subheader (FSH) is included in a MAC PDU that has been subjected to packing or fragmentation. Each of the PSH and FSH includes a 2-bit Fragment Control (FC) field, which indicates whether a corresponding fragment is the first or last fragment or which intermediate fragment it is. Specifically, if the FC bits are “10”, it indicates that a corresponding fragment is the first MAC SDU fragment; “01” indicates that a corresponding fragment is the last MAC SDU fragment; and “11” indicates that a corresponding fragment is a middle MAC SDU fragment. If the FC bits are “00”, it indicates that a corresponding MAC SDU is not fragmented.

Since the transmitter performs packing or fragmentation according to the circumstances, a complete MAC SDU and a MAC SDU fragment may coexist in a single MAC PDU. Through the GMH and the MAC subheaders, the transmitter informs the receiver of such a configuration of the MAC PDU. The simultaneous packing and fragmentation in a single MAC PDU enables efficient utilization of wireless resources.

The PSH and the FSH are mutually exclusive in a single MAC PDU. Accordingly, one FSH or alternatively N PSHs may exist in the same MAC PDU. For example, if two or more MAC SDUs and a MAC SDU fragment are carried in the same MAC PDU, a PSH must be used for each of the MAC SDUs and the MAC SDU fragment.

In the case of a non-ARQ connection, the MAC PDU 170 in FIG. 3 does not include the CRC 176, so that MAC SDUs are packed as shown in FIG. 5.

FIG. 5 shows conventional MAC PDUs. Here, it is assumed that the MAC CPS 122 in FIG. 5 packs first to third MAC SDUs 501, 502 and 503 in a transmission queue 500 to generate a MAC PDU. The first SDU (SDU_1) 501 has a size of A, the second SDU (SDU_2) 502 has a size of B, and the third SDU (SDU_Last) 503 has a size of C. However, it can be seen from FIG. 5 that the MAC SDUs 501, 502 and 503 in the transmission queue 500 are not packed into the single MAC PDU 520. After the first and second MAC SDUs 501 and 502 are packed into the MAC PDU 520, the third or last MAC SDU (SDU_Last) 503 cannot be packed into the MAC PDU 520 although the remaining area of the MAC PDU 520 has a size of C or a size of C+ (PSH-1) since a corresponding PSH 527 must be added to the last MAC SDU 503.

The MAC CPS 122 is thus subjected to a plurality of processes to transmit all of the MAC SDUs 510, 502 and 503 in the transmission queue 500. As shown in FIG. 5, the transmitter first generates and transmits a MAC PDU 510 composed of the MAC SDUs 501 and 502. The MAC PDU 510 has an empty area 517 having the same size (=C) as that of the last SDU 503. After transmitting the MAC PDU 510, the MAC CPS 122 requests a bandwidth for transmission of the last SDU 503 through the higher layer 130 and is allocated the bandwidth in response to the request. The MAC CPS 122 then generates and transmits a MAC PDU 530 for transmission of the last SDU 503.

As described above, when the empty area of the MAC PDU has the same size as that of the last SDU to be transmitted or has a size of (PSH+the last SDU size−1), fragmentation of the last SDU is required since the MAC PDU has no space for allocation to a PSH corresponding to the last SDU, and as circumstances demand, it is also necessary to perform a new bandwidth request/allocation and generation of a new MAC PDU.

### SUMMARY OF THE INVENTION

Therefore, the present invention has been made in view of at least the above problem, and it is an object of the present invention to provide an apparatus and a method for transmitting data in a broadband wireless communication system and an apparatus and a method for receiving data in the same, which avoids a data transmission delay caused by unnecessary header field transmission, thereby increasing the traffic data rate.

In accordance with one aspect of the present invention, the above and other objects can be accomplished by the provision of a method for transmitting Medium Access Control (MAC) Protocol Data Units (PDUs) in a broadband wireless communication system, the method including the steps of generating a MAC PDU and determining if an empty area exists in the generated MAC PDU; if an empty area exists in the generated MAC PDU, determining if there exists a complete Service Data Unit (SDU) to be transmitted having a size that is less than or equal to a size of the empty area; if the complete SDU to be transmitted exists, incorporating into the MAC PDU as a last payload piece the complete SDU without a corresponding subheader; and setting a Generic MAC Header (GMH) of the MAC PDU to indicate that a No Overhead Last complete SDU (NOLS) exists in the MAC PDU; and transmitting the MAC PDU.

In accordance with another aspect of the present invention, there is provided a method for receiving MAC PDUs in a broadband wireless communication system, the method including the steps of upon receipt of a MAC PDU, analyzing a GMH of the MAC PDU and determining if an NOLS exists in the MAC PDU; if an NOLS exists in the MAC PDU, sequentially monitoring the PSHs included in the MAC PDU and detecting a last PSH therein; and separating an SDU corresponding to the NOLS from the MAC PDU with reference to the last PSH.

### BRIEF DESCRIPTION OF THE DRAWINGS

The above and other objects, features and other advantages of the present invention will be more clearly understood from the following detailed description taken in conjunction with the accompanying drawings, in which:

FIG. 1 illustrates the configuration of a general broadband wireless communication system;

FIG. 2a illustrates a protocol stack architecture of a subscriber station in a general broadband wireless communication system;

FIG. 2b illustrates packing of Service Data Units (SDUs) into a PDU and fragmentation of an SDU into PDUs;

FIG. 3 illustrates a general MAC PDU structure;

FIG. 4 illustrates a GMH structure and details of GMH fields proposed in the specification 802.16REVd/D4;

FIG. 5 illustrates conventional MAC PDUs;

FIG. 6 illustrates a MAC PDU according to an embodiment of the present invention;

FIG. 7 is a block diagram showing a transmitter according to an embodiment of the present invention;

FIG. 8 is a flow chart showing a transmission method according to an embodiment of the present invention;

FIG. 9 is a block diagram showing a receiver according to an embodiment of the present invention; and

FIG. 10 is a flow chart showing a reception method according to an embodiment of the present invention.

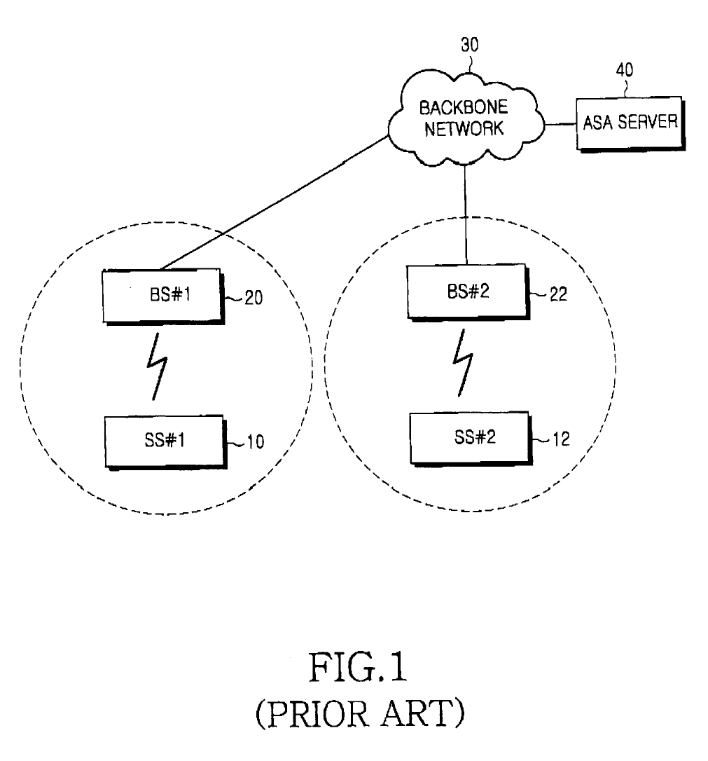

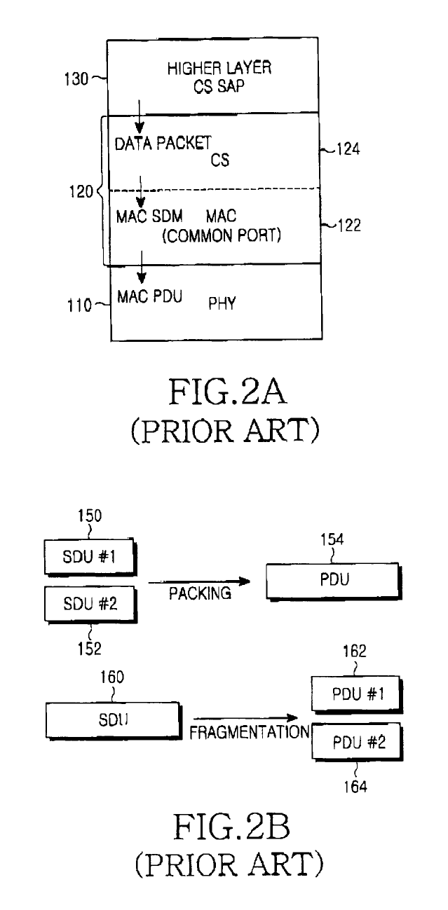

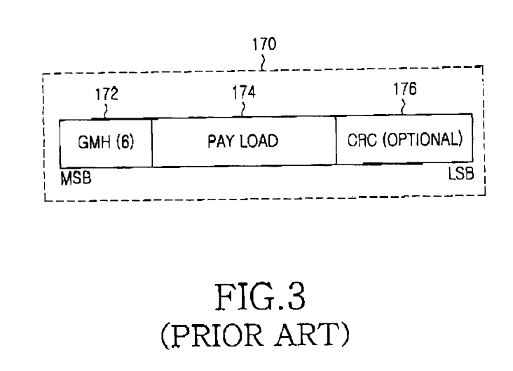

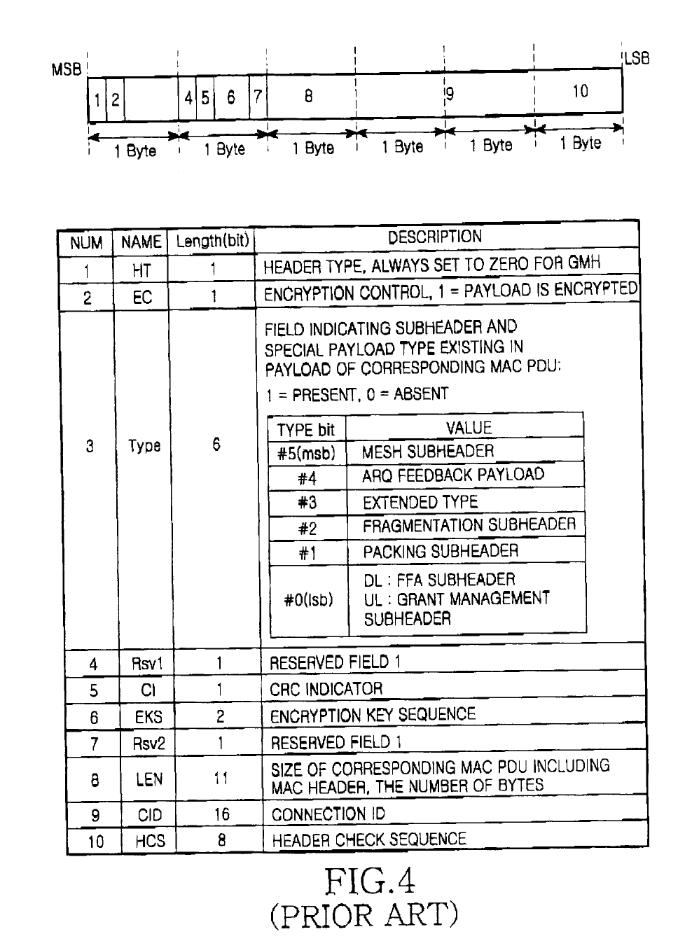

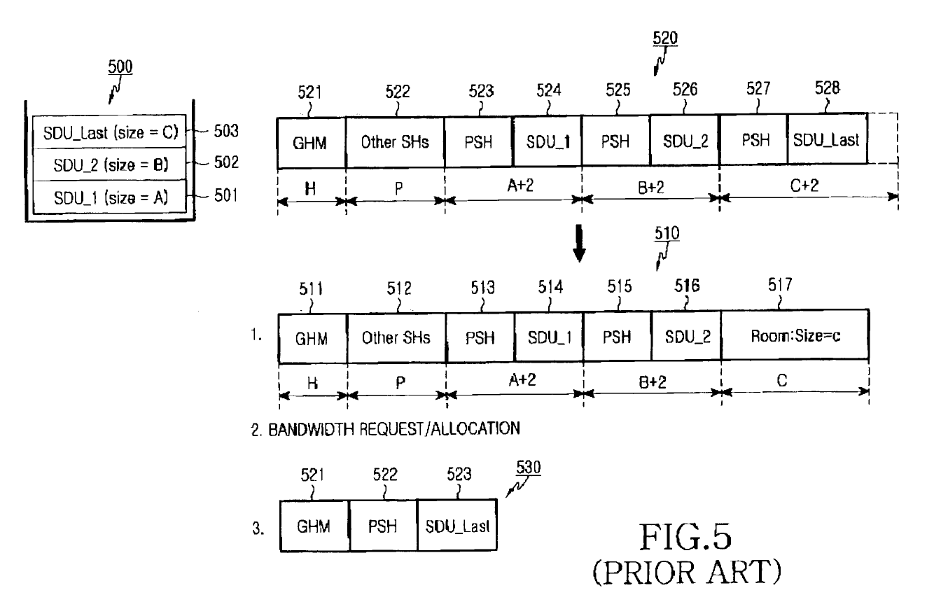

### DETAILED DESCRIPTION OF THE PREFERRED EMBODIMENTS

Now, preferred embodiments of the present invention will be described in detail with reference to the annexed drawings. In the following description, a detailed description of known functions and configurations incorporated herein will be omitted when it may obscure the subject matter of the present invention.

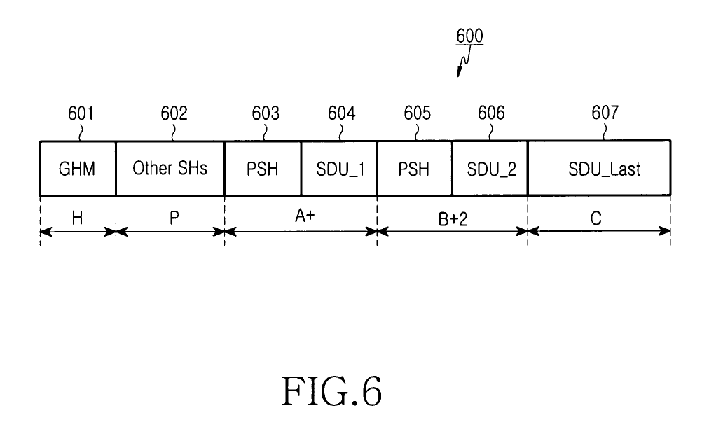

FIG. 6 shows a MAC PDU according to an embodiment of the present invention.

If the remaining space of the MAC PDU can carry a Complete SDU (CSDU) or an unfragmented SDU suspended in a queue managed in a corresponding connection but is not sufficient to append its associated PSH to the CSDU, an additional PSH overhead is caused with unnecessary operations such as fragmentation and signaling for bandwidth request and allocation, according to the existing specifications. To resolve this problem, if a complete SDU or an unfragmented SDU having no PSH exists in a MAC PDU, the present invention uses a “reserved” bit in a Generic MAC Header (GMH) of the MAC PDU to indicate the existence of the complete SDU without a PSH. Specifically, if the reserved bit in a GMH of a MAC PDU is set to “1”, it indicates that the MAC PDU includes one or more packed payload pieces (i.e. packed SDUs with PSHs) and a complete SDU having no PSH. Two separate reserved bits remain in a GMH according to the current specification. The present invention uses one of the two reserved bits, which will hereinafter be referred to as an “NOLS bit”. Here, NOLS stands for “No Overhead Last complete SDU”. That is, the NOLS is a complete SDU having no PSH. According to the present invention, a GMH of a MAC PDU includes an NOLS bit as shown in the following table.

TABLE 1

| | | Length | |
|---|---|---|---|
| Num | Name | (bit) | Description |
| 1 | HT | 1 | Header Type, always set to 0 for GMH |
| 2 | EC | 1 | Encryption Control, |
| | | | 1: Payload is encrypted |
| 3 | Type | 6 | field indicating subheader and special payload |
| | | | type existing in payload of corresponding MAC |
| | | | PDU |
| | | | 1: present, |
| | | | 0: absent |
| 4 | NOLS | 1 | field indicating whether NOLS exists in |
| | | | corresponding MAC PDU at the end thereof |
| | | | 0: absent |
| | | | 1: present |
| 5 | CI | 1 | CRC indicator |
| 6 | EKS | 2 | Encryption Key Sequence |
| 7 | Rsv2 | 1 | reserved field 1 |
| 8 | LEN | 11 | size of MAC PDU including MAC Header, the |
| | | | number of bytes |
| 9 | CID | 16 | Connection ID |
| 10 | HCS | 8 | Header Check Sequence |

If the NOLS of the GMH, which is updated as in Table 1 according to the present invention, is set to 1, this indicates that an NOLS is present in the corresponding MAC PDU at the end thereof. A bit denoted by “Rsv2” in Table 1 can be used as the NOLS bit.

If an NOLS exists in a MAC PDU, a PSH generated from the MAC PDU may have two FC values. If a payload is followed by an empty area in a MAC PDU to be formed, this indicates that an SDU (i.e. the payload) inserted, as a payload, into the MAC PDU at the front portion thereof is not a first or intermediate SDU segment. If a first or intermediate SDU segment is included in the MAC PDU at a front portion thereof, an empty area cannot follow the first or intermediate SDU segment.

Accordingly, if an NOLS exists in a MAC PDU, a PSH of the MAC PDU cannot have an FC value indicating a first or intermediate SDU segment. That is, the PSH may have FC values of “00” and “01”, and cannot have the other FC values of “10” and “11”. The present invention uses the MSB of an FC field of a PSH in a MAC PDU to indicate whether the PSH is the last PSH of the MAC PDU. If the MSB is “1”, it indicates that the corresponding PSH is the last PSH of the MAC PDU. For example, if an FC field in a PSH has an FC value of “00” or “01” with an NOLS bit set to “1”, it indicates that an SDU segment or a complete SDU identified by the PSH is followed by another PSH. PSHs in the MAC PDU are sequentially checked in this manner. If a PSH having an FC value of “1x” (x: variable, i.e. 0 or 1) is detected in this check procedure, it indicates that the PSH is the last PSH of the MAC PDU and an SDU segment or a complete SDU identified by the PSH is followed by an NOLS.

Table 2 illustrates the meanings of FC values of a PSH in a MAC PDU according to the present invention.

TABLE 2

| combinations | NOLS | FC | description |
|---|---|---|---|
| 1 | NOLS = 0 | 00 | To indicate a complete SDU, which is |
| | | | followed by a new PSH. |
| | | 01 | To indicate the last fragment of an SDU, |
| | | | which is followed by a new PSH. |
| | | 10 | Impossible |
| | | 11 | Impossible |
| 2 | NOLS = 1 | 00 | To indicate a complete SDU, which is |
| | | | followed by a new PSH. |
| | | 01 | To indicate the last fragment of an SDU, |
| | | | which is followed by a new PSH. |
| | | 10 | To indicate a complete SDU with the last |
| | | | PSH of the PDU, which is followed by an |
| | | | NOLS. |
| | | 11 | To indicate a last SDU segment with the |
| | | | last PSH of the PDU, which is followed |
| | | | by an NOLS. |

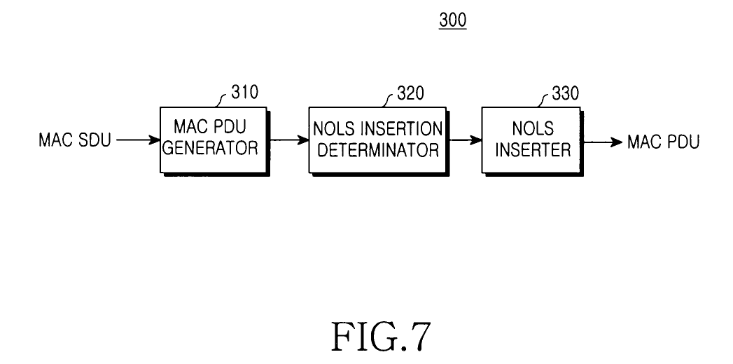

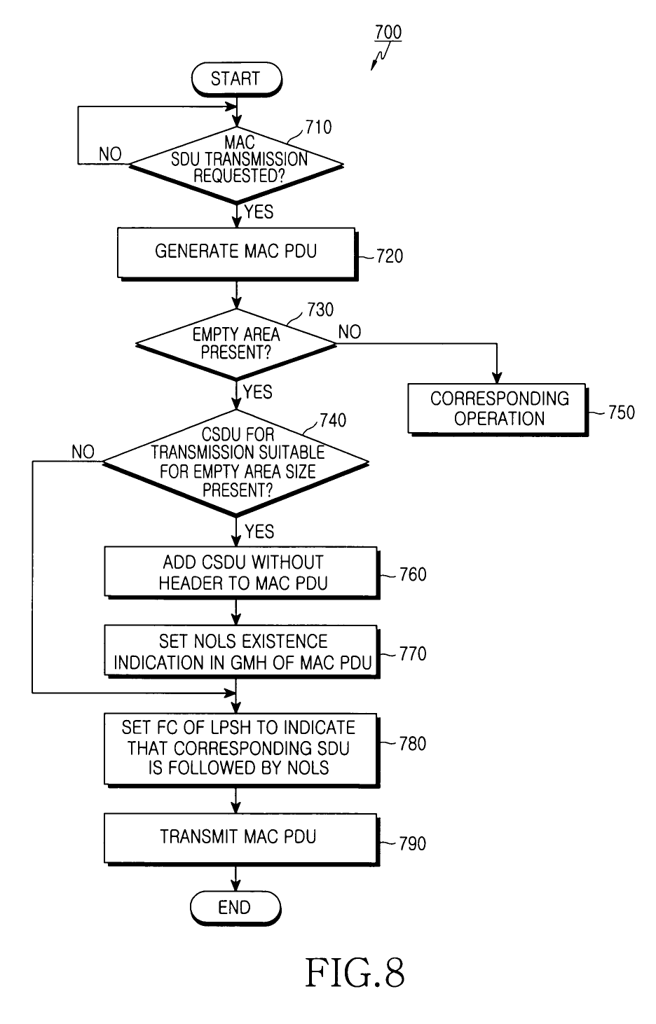

An apparatus and method for transmitting MAC PDUs according to the present invention will now be described with reference to FIGS. 7 and 8.

FIG. 7 is a block diagram showing a MAC PDU transmitter according to an embodiment of the present invention, and FIG. 8 is a flow chart showing a MAC PDU transmission method according to an embodiment of the present invention.

As shown in FIG. 7, the transmitter 300 includes a MAC PDU generator 310, an NOLS insertion determinator 320 and an NOLS inserter 330. The MAC PDU generator 310 generates a MAC PDU to be transmitted, determines if the generated MAC PDU has an empty area, and then provides the determination to the NOLS insertion determinator 320. If the generated MAC PDU has an empty area, the NOLS insertion determinator 320 determines if there is a Complete SDU (CSDU) to be transmitted, which is suitable for the size of the empty area of the MAC PDU, and provides the determination to the NOLS inserter 330. The size of the empty area of the MAC PDU, which is less than the sum of the size of the CSDU to be transmitted and the size of the corresponding subheader, must be equal to or greater than that of the CSDU to be transmitted. If the size of the subheader of the MAC PDU is 2 bytes and the size of the CSDU to be transmitted is R bytes, a suitable size of the empty area is R or R+1 bytes. If the size of the subheader of the MAC PDU is 3 bytes and the size of the CSDU to be transmitted is R bytes, a suitable size of the empty area is R, R+1 or R+2 bytes.

If the NOLS inserter 330 is informed by the NOLS insertion determinator 320 that there is a CSDU suitable for the size of the empty area of the MAC PDU, the NOLS inserter 330 incorporates the CSDU without a corresponding subheader, as the last piece of the payload of the MAC PDU, into the MAC PDU.

The NOLS inserter 330 then sets information, indicating that there is an NOLS in the MAC PDU, to the GMH of the MAC PDU. The NOLS inserter 330 also sets an FC value of the Last PSH (LPSH) of the MAC PDU to indicate that an SDU segment or a complete SDU identified by the last PSH is followed by an NOLS, and then transmits the MAC PDU.

The method for transmitting a MAC PDU according to an embodiment of the present invention will now be described with reference to FIG. 8. The MAC CPS 122 in the transmitter determines, at step 710, if it receives a MAC SDU transmission request from the CS layer. If the MAC CPS 122 receives a MAC SDU transmission request from the CS layer, the MAC CPS 122 moves to step 720 to generate a MAC PDU to be transmitted. Then, at step 730, the MAC CPS 122 determines if an empty area exists in the generated MAC PDU. If there is no empty area in the generated MAC PDU, the MAC CPS 122 moves to step 750 to operate in the same manner as the conventional method.

If an empty area exists in the generated MAC PDU, the MAC CPS 122 moves to step 740 to determine if there is a CSDU to be transmitted, which is suitable for the size of the empty area of the MAC PDU. As described above, the size of the empty area of the MAC PDU must be equal to or greater than that of the CSDU to be transmitted.

If there is a CSDU to be transmitted, which is suitable for the size of the empty area of the MAC PDU, the MAC CPS 122 moves to step 760 to incorporate the CSDU without a corresponding subheader, as the last piece of the payload, into the MAC PDU. Then, the MAC CPS 122 moves to step 770 to set information indicating that there is an NOLS in the MAC PDU, in the GMH of the MAC PDU. As described above, the MAC CPS 122 uses one of the two reserved bits in the GMH as an NOLS bit to set information indicating that there is an NOLS in the MAC PDU.

Then, at step 780, the MAC CPS 122 sets an FC value of the Last PSH (LPSH) of the MAC PDU to indicate that an SDU segment or a complete SDU identified by the last PSH is followed by an NOLS. If an empty area exists in the MAC PDU at the end thereof, a PSH of the MAC PDU cannot have an FC value indicating a first or intermediate SDU segment. That is, a PSH of a MAC PDU with an NOLS bit set to indicate that an NOLS exists in a GMH of the MAC PDU may have FC values of “00” and “01”, and cannot have the other FC values of “10” and “11”. The present invention uses the MSB of an FC field of a PSH in a MAC PDU to indicate if the PSH is the last PSH of the MAC PDU. If the MSB is “1”, it indicates that the corresponding PSH is the last PSH of the MAC PDU. For example, if an FC field in a PSH has an FC value of “00” or “01” with an NOLS bit set to “1”, it indicates that an SDU segment or a complete SDU identified by the PSH is followed by another PSH. If an FC field in a PSH has an FC value of “10” or “11” with an NOLS bit set to “1”, it indicates that an SDU segment or a complete SDU identified by the PSH is followed by an NOLS. Then, at step 790, the MAC CPS 122 transmits the MAC PDU.

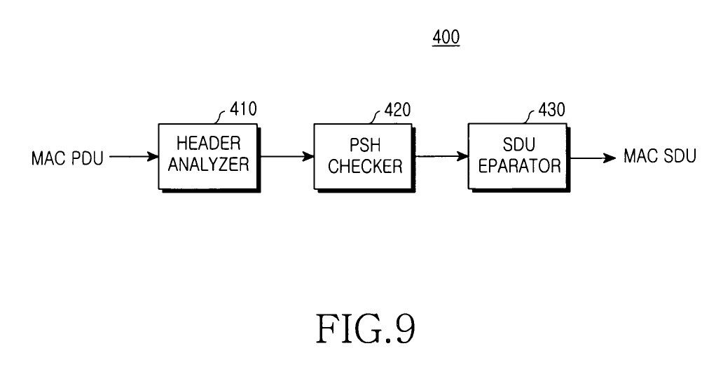

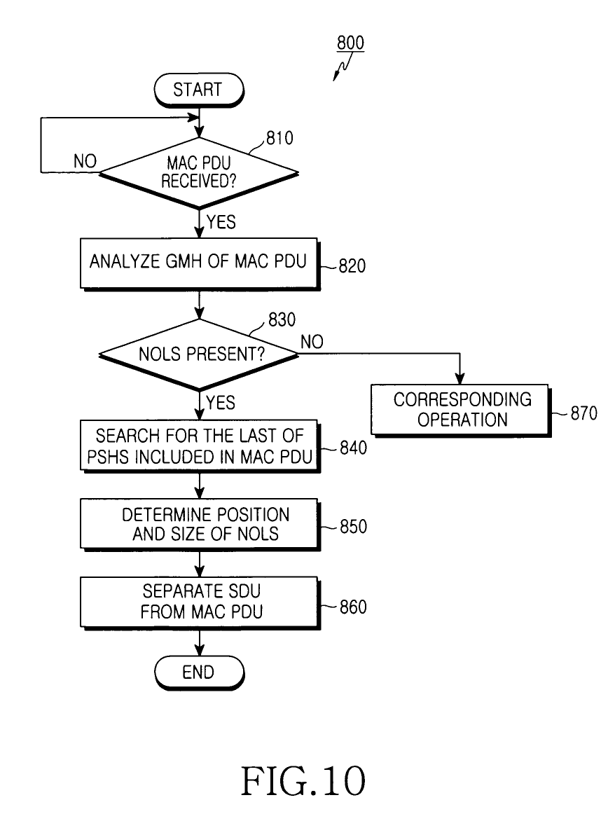

An apparatus and method for receiving MAC PDUs according to the present invention will now be described with reference to FIGS. 9 and 10.

FIG. 9 is a block diagram showing a MAC PDU receiver according to an embodiment of the present invention, and FIG. 10 is a flow chart showing a MAC PDU reception method according to an embodiment of the present invention.

First, as shown in FIG. 9, the receiver 400 includes a header analyzer 410, a PSH checker 420 and an SDU separator 430. If the header analyzer 410 receives a MAC PDU, the header analyzer 410 analyzes a GMH of the received MAC PDU to determine if the NOLS bit in the GMH is set to “1”, and provides the determination to the PSH checker 420. If the NOLS bit is set to “1”, it indicates that an NOLS exists, as the last payload piece, in the MAC PDU.

If the NOLS bit is set to “1”, the PSH checker 420 sequentially monitors the PSHs included in the MAC PDU. If a PSH having an FC value of “1x” (x; variable) is detected in this procedure, the PSH checker 420 determines that the PSH is the last PSH of the MAC PDU, and notifies the SDU separator 430 of the determination.

The SDU separator 430 refers to a length field in the last PSH to determine the start position of the NOLS. A length field in a PSH includes the length information of an SDU corresponding to the PSH. Since the SDU separator 430 can determine the length of an SDU corresponding to the last PSH based on a length field in the last PSH, the SDU separator 430 can determine the start position of the NOLS subsequent to the SDU corresponding to the last PSH. The SDU separator 430 separates an SDU segment and MAC SDUs including the NOLS from the MAC PDU, and routes them to the higher layer.

The method for receiving a MAC PDU according to an embodiment of the present invention will now be described with reference to FIG. 10. As shown in FIG. 10, the receiver according the embodiment of the present invention determines, at step 810, if a MAC PDU is received from the PHY layer 110. Upon receipt of a MAC PDU, the MAC CPS 122 analyzes a GMH of the received MAC PDU. Then, the MAC CPS 122 determines, at step 830, if an NOLS bit in the GMH is set to “1”. If the NOLS bit is set to “1”, this indicates that an NOLS exists in the MAC PDU at the end of the payload thereof. If the NOLS bit in the GMH is not set to “1”, the MAC CPS 122 moves to step 870 to operate in the same manner as the conventional method.

If the NOLS bit in the GMH is set to “1”, the MAC CPS 122 moves to step 840 to sequentially monitor the PSHs included in the received MAC PDU. If a PSH having an FC value of “1x” (x: variable, i.e. 0 or 1) is detected in this procedure, the MAC CPS 122 determines that the PSH is the last PSH of the MAC PDU. Then, the MAC CPS 122 moves to step 850 to refer to a length field in the last PSH to determine the start position of the NOLS. Then, at step 860, the MAC CPS 122 separates an SDU segment and MAC SDUs including the NOLS from the MAC PDU, and routes them to the higher layer. Here, the MAC CPS 122 determines that a Fragment Sequence Number (FSN) of the NOLS is “x+1” when an FSN of the last PSH is “x”.

As apparent from the above description, the present invention provides an apparatus and a method for transmitting data in a broadband wireless communication system and an apparatus and a method for receiving data in the same, which avoids a data transmission delay caused by unnecessary header field transmission, thereby increasing the traffic data rate. Accordingly, the present invention can avoid unnecessary operations such as additional bandwidth allocation and signaling for bandwidth allocation, and can reduce latency due to the unnecessary operations.

Although the preferred embodiments of the present invention have been disclosed for illustrative purposes, those skilled in the art will appreciate that various modifications, additions and substitutions are possible, without departing from the scope and spirit of the invention as disclosed in the accompanying claims. Accordingly, the scope of the present invention should not be limited to the above embodiments, but defined by the accompanying claims as well as equivalents thereof.

1. A method for transmitting Medium Access Control (MAC) Protocol Data Units (PDUS) in a broadband wireless communication system, the method comprising the steps of:
a) generating a MAC PDU and determining if an empty area exists in the generated MAC PDU;
b) if an empty area exists in the generated MAC PDU, determining if there exists a complete Service Data Unit (SDU) to be transmitted having a size that is equal to or less than a size of the empty area;
c) if the complete SDU to be transmitted exists, incorporating into the MAC PDU as a last payload piece the complete SDU without a corresponding subheader;
d) setting a Generic MAC Header (GMH) of the MAC PDU to indicate that a No Overhead Last complete SDU (NOLS) exists in the MAC PDU; and
e) transmitting the MAC PDU.

2. The method according to claim 1, further comprising the step of:
setting a Fragment Control (FC) field of a last Packing Subheader (PSH) of the MAC PDU to indicate that an SDU identified by the last PSH is followed by an NOLS.

3. The method according to claim 1, wherein the size of the empty area of the MAC PDU is equal to a size of the complete SDU to be transmitted.

4. The method according to claim 1, wherein the size of the empty area of the MAC PDU is less than a sum of the size of the complete SDU to be transmitted and a corresponding subheader and greater than the size of the complete SDU to be transmitted.

5. The method according to claim 1, wherein step d) includes the step of setting the GMH by using a specific bit of the GMH as an NOLS bit.

6. An apparatus for transmitting Medium Access Control (MAC) Protocol Data Units (PDUs) in a broadband wireless communication system, the apparatus comprising:
a MAC PDU generator for generating a MAC PDU to be transmitted, determining if an empty area exists in the generated MAC PDU, and outputting the determination;
an NOLS insertion determinator for, if informed that an empty area exists in the MAC PDU, determining if there exists a complete SDU to be transmitted having a size that is less than or equal to a size of the empty area, and outputting the determination; and
an NOLS inserter for, if informed that the complete SDU to be transmitted exists, incorporating into the MAC PDU as a last payload piece the complete SDU without a corresponding subheader, and setting a GMH of the MAC PDU to indicate that an NOLS exists in the MAC PDU.

7. The apparatus according to claim 6, wherein the NOLS inserter sets an FC field of a last PSH of the MAC PDU to indicate that an SDU identified by the last PSH is followed by an NOLS.

8. A method for receiving MAC PDUs in a broadband wireless communication system, the method comprising the steps of:
a) upon receipt of a MAC PDU, analyzing a GMH of the MAC PDU and determining if an NOLS exists in the MAC PDU;
b) if an NOLS exists in the MAC PDU, sequentially monitoring PSHs included in the MAC PDU and detecting a last PSH therein; and
c) separating an SDU corresponding to the NOLS from the MAC PDU with reference to the last PSH.

9. The method according to claim 8, further comprising the step of:
determining that a Fragment Sequence Number (FSN) of the NOLS is “x+1” when an FSN of the last PSH is “x”.

10. The method according to claim 8, wherein step b) includes the step of detecting a PSH having an FC value of 1x where x is a variable.

11. The method according to claim 8, wherein step a) includes the step of determining if an NOLS bit is set in the GMH.

12. The method according to claim 8, wherein step c) includes the step of determining a start position of the NOLS with reference to a length field of the last PSH.

13. An apparatus for receiving MAC PDUs in a broadband wireless communication system, the apparatus comprising:
a header analyzer for, upon receipt of a MAC PDU, analyzing a GMH of the MAC PDU and determining if an NOLS exists in the MAC PDU;
a PSH checker for, if an NOLS exists in the MAC PDU, sequentially monitoring PSHs included in the MAC PDU and detecting a PSH having an FC value of 1X, where X is any number, as a last PSH of the MAC PDU; and
an SDU separator for determining a start position of the NOLS with reference to a length field in the last PSH, and separating an SDU corresponding to the NOLS from the MAC PDU.
